(19) United States
(12) Patent Application Publication
(10) Pub. No.: US 2017/0112106 A1
(43) Pub. Date: Apr. 27, 2017

(54) Handle For Structure For Attracting And Accumulating Aquatic Organisms

(71) Applicant: Matthew E. Marsden, Signal Mountain, TN (US)

(72) Inventor: Matthew E. Marsden, Signal Mountain, TN (US)

(21) Appl. No.: 15/399,559

(22) Filed: Jan. 5, 2017

Related U.S. Application Data
(63) Continuation-in-part of application No. 14/513,257, filed on Oct. 14, 2014.
(60) Provisional application No. 62/416,688, filed on Nov. 2, 2016.

(51) Int. Cl. A01K 61/73; A01K 97/00; A01K 61/78; A01K 61/10

(52) U.S. Cl. CPC A01K 61/73; A01K 61/10; A01K 97/00; A01K 61/78

(57) ABSTRACT

A handle for an aquatic aggregation apparatus that upon placement by measured passage with a line connected thereto provides for shelteringly attracting and accumulating aquatic organisms, the handle defined by an elongated member configured with a medial arcuate portion and a pair of distal arcuate seating portions for passage through and engagement with respective longitudinal opposing slots of a supporting member that further receives elongated slats through spaced-apart slots therein to define arms for the attracting and accumulating of aquatic organisms to and about the aggregation apparatus for facilitating fishing habitats, allowing the habitat apparatus to be hung from a dock or retrieved with a boat hook for ease in removal and relocation.

### FIELD OF THE INVENTION

The invention relates generally to artificial structures for attracting fish. More specifically, the invention relates to handle structures for suspending or positioning a fish aggregation apparatus within an aquatic environment.

### BACKGROUND OF THE INVENTION

In aquatic environments underwater structures such as rocks, reefs, logs, stumps, brush piles, and vegetation are all natural fish attractors that create a habitat for fish and aquatic organisms to thrive. Unfortunately, as ponds, lakes, and reservoirs age, the habitat is lost through the normal process of decay and sedimentation, and the result is a corresponding reduction in fish species, fishing spots, and fishing-related commerce.

Prior art approaches to creating fish habitats in many instances have been simply felled, discarded pine or cedar trees, especially retired Christmas trees. Sport fishermen often deposit these trees in convenient fishing locations, such as near docks, to provide a habitat for the fish that they wish to pursue. The fish eventually gather near the protective habitat, and the fishing location is enhanced.

Regrettably, many prior art fish habitats made of woody materials routinely snag fish hooks and thereby severely limit the beneficial aspects of the fish habitat and convenient fishing location. Specifically, pine, cedar, and fir trees include a plurality of small branches which are easily snagged by conventional fish hooks. In addition to snagging problems associated with these natural fish attractors, their woody composition degrades and decomposes with time, as well. Accordingly, there exists a need for a means by which fish habitats can be replaced or created in a manner that is quick, easy, effective, and long-lasting. The helical aggregation apparatus of the present invention fulfills this need.

Further, placement of apparatus for creating fish habitats has drawbacks. Merely tossing the fish habitat structure into a body of water does not assure appropriate positioning relative to a bottom surface, to a dock or pier from which fishing activities occur, or other fishing places. A fish habitat structure having a desired orientation (i.e., vertical) may sit awkwardly at an oblique angle or may fall over to other than such orientation. The body of water may have low visibility below a shallow depth and thereby the placement may not be readily determined or evaluated.

Other types of artificial fish beds or reef systems are disclosed in the patent literature, including U.S. Pat. No. 5,201,136 issued in the name of La Morte et al.; U.S. Pat. No. 4,993,362 issued in the name of Jimbo; and U.S. Pat. No. 4,947,791 issued in the name of Laier et al.

Fish aggregating systems in an anchored or floating mode are described in U.S. Pat. No. 4,916,845 issued in the name of Aydelette, Sr. et al.; US. Pat. No. 4,727,672 issued in the name of Hill et al.; and U.S. Pat. No. 4,471,552 issued in the name of McIntosh et al. A submersible object with a bait compartment for attracting fish is described in U.S. Pat. No. 5,555,670, issued in the name of Troutman et al. A fish attracting basin stump is described in U.S. Pat. No. 5,272,829 issued in the name of Roberts et al.

Accordingly, there is a need in the art for an improved structure that facilitates the handling and measured placement of fish habitat structures and for improved fish habitat structures for placement in aquatic environments. It is to such that the present invention is directed.

### SUMMARY OF THE INVENTION

The present invention meets the need in the art for facilitating placement and use of a fish aggregation apparatus as an aquatic habitat, with a unit that is simpler, inexpensive, and non-degradable over known fish aggregation apparatus, while easy to assemble and use, as well as easy to retrieve and move with a handle for use in a different location. The handle enables with a line for measured disposing of the fish aggregation apparatus in an aquatic environment for attracting and accumulating aquatic organisms, which structure is formed of a central pipe or supporting member having cut outs through which are inserted elongated slats made of solid, generally rigid, 100% PVC material.

In another aspect, the present invention provides a fish aggregation apparatus comprising a linearly elongated, cylindrical supporting member; and a plurality of linearly elongated slats extending perpendicularly to the cylindrical supporting member. The supporting member is formed with aligned pairs of opposing slat-receiving cut-outs in a wall of the supporting member, and the pairs of slat-receiving cut-outs are spaced vertically and accurately relative to an adjacent pair of the slat-receiving cut-outs. The supporting member, when engaged with said slats, forms a generally helix-like structure for providing an artificial habitat for fish. An elongated member formed with an arcuate medial portion concavely curved in a first direction and two leg portions extending longitudinally therefrom at diverging angles to respective opposing distal ends that each define a foot for engaging an end of the supporting member. The elongated member, being attached to a line, provides measured placement of the fish aggregation apparatus within an aquatic environment.

In an another aspect, the present invention provides a handle for engaging a tubular member of an aquatic tree structure, comprising a continuous elongated member having opposing distal ends and the elongated member formed with an arcuate medial portion concavedly curved in a first direction to define an upper end of the handle. A pair of opposing legs extendfrom the medial portion at diverging angles relative to a radial line through a center point of the medial portion to a respective engaging foot. Each engaging foot having an accurate seating portion and a stub extending to the respective distal end, the arcuate seating portion concavedly curved in a second direction opposing the first direction for extending outwardly of a longitudinal slot in a wall of a tubular supporting member of an aquatic tree structure to dispose the seating portion therein. The handle, being engaged to the tubular supporting member of the aquatic tree structure for attaching a line for measured placement of the aquatic tree structure in an aquatic environment.

Alternatively, the use of coupling connections permits joining one habitat structure to another in order to form a larger habitat structure. Any method of joinder may be used, but one alternative is a standard plumbing coupling, and the other type is a “bell and spigot.” The coupling devices are inserted into, or may be fitted onto, the tubular ends of the habitat structure such that opposing ends may be mated to join two habitat structures together.

Therefore, it is an object of the present invention to provide a fish aggregation apparatus as a fish habitat that provides an artificial habitat for fish, thereby promoting the proliferation of fish species and the enjoyment of sport fishing.

It is another object of the present invention to provide a fish habitat that encourages the growth of other aquatic life and provides protection from predators.

It is still another object of the present invention to provide a fish habitat that allows fish to feed.

It is another object of the present invention to provide an artificial fish habitat with a base made of large diameter PVC pipe.

It is another object of the present invention to provide an artificial fish habitat with bar slats that pass through the base and that are disposed at 60 degrees or other angles to adjacent slats, thereby forming a helical shaped structure for fish to weave in and out through.

It is another object of the present invention to provide an artificial fish habitat that rests on a pond, lake or reservoir bottom.

It is still another object of the present invention to provide a handle for a fish habitat structure that can be measuredly moved or removed from a body of water.

It is another object of the present invention to provide an artificial fish habitat that can be used to replace natural habitats that have been destroyed.

Briefly described according to one embodiment of the present invention, a helical fish aggregation apparatus is disclosed for providing an artificial habitat for fish seeking refuge from predators or seeking other fish or food to eat.

The present invention is comprised of PVC piping and bar slats arranged in a helical pattern spaced approximately 60 degrees apart and forming a structure approximately five feet long by six feet wide, although larger or smaller dimensions may be used. The slat installation is a compressed fit into and through respective profile cut-out sections of the supporting member, forming a self-expanding, spring-lock, tension fit design. The slats are compressed using hand pressure and positioned through the supporting member. Tension fit design allows the slats to be installed and secured without the use of mechanical fasteners, solvent welds, or adhesive materials. When the slat is in position, it is released; and the spring-loaded sides of the slat then wedge tight against the walls of the supporting member, securing the slat in place. Holes may be drilled in each end of the central supporting member so that a hook may be inserted in one end, allowing the habitat to be hung from a dock or tethered to another stationary object, or retrieved with a boat hook for ease in removal and relocation.

With the handle disclosed herein, the artificial habitat is lowered to the bottom of a body of water, or may be suspended above the bottom, and provides cover for any fish seeking food or refuge from predators. The invention can enhance the desirability of convenient fishing spots by providing an area where fish tend to congregate. The use of the present invention provides fish an artificial habitat in areas where natural ones do not exist.

Objects, features and advantages of the present invention will become apparent upon a reading of the following detailed description in conjunction with the drawings and the appended claims.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an artificial fish habitat constructed in accordance with the principles of a first preferred embodiment of the present invention, and shown in use submerged vertically in a body of water with a fish hook descended through the openings between slats;

FIG. 2 is a perspective view of an artificial fish habitat constructed in accordance with the principles of a first preferred embodiment of the present invention, and shown in use submerged horizontally in a body of water;

FIG. 3 is a perspective view of a helical fish aggregation apparatus according to the preferred embodiment of the present invention;

FIG. 4 is a perspective view of a slat of the present invention, showing slats;

FIG. 5 is a perspective view of the supporting member of the present invention, showing slat member cutouts and supporting member holes;

FIG. 6 is a front elevation view thereof;

FIG. 7 is an elevation view rotated 45 degrees from the view depicted in FIG. 4;

FIG. 8 is an elevation view rotated 45 degrees from the view depicted in FIG. 5;

FIG. 9 is a back elevation view rotated 45 degrees from the view depicted in FIG. 6;

FIG. 10 is a top plan view of a helical fish aggregation apparatus according to the preferred embodiment of the present invention;

FIG. 11 is a bottom plan view thereof; and FIG. 12 is a perspective view of two helical fish aggregation apparatuses joined together according to the preferred embodiment of the present invention.

FIG. 13 is a perspective detailed view of an alternate embodiment of the helical fish aggregation apparatus according to the present invention.

FIG. 14 is a perspective detailed view of a handle for use with the helical fish aggregation apparatus illustrated in FIG. 13.

FIG. 15A is a front plan view of a handle for use with the helical fish aggregation apparatus illustrated in FIG. 13 and FIG. 15B is a side elevational view of the handle.

FIG. 16 is a perspective view of a slat being handled for installation in the helical fish aggregation apparatus illustrated in FIG. 13.

FIG. 17 is a perspective view of slats being installed in the helical fish aggregation apparatus.

FIG. 18 is a perspective view of slats in a subsequent step being installed in a bottom portion of the helical fish aggregation apparatus.

FIG. 19 is a perspective view of slats in a subsequent step being installed in an intermediate portion of the helical fish aggregation apparatus.

FIG. 20 is a perspective view of a bottom end of the helical fish aggregation apparatus having a support member and weight for positioning the helical fish aggregation apparatus on a bottom surface of an aquatic environment.

FIG. 21 is a perspective view of a placement of the helical fish aggregation apparatus in an aquatic environment.

FIG. 22A is a perspective cut-away view of a bottom end of the helical fish aggregation apparatus with a weighted base for vertical placement on a bottom surface of an aquatic environment (as shown in perspective view in FIG. 22B.

FIG. 23 is a perspective view of the helical fish aggregation apparatus attached to a cleat of dock or pier.

### DETAILED DESCRIPTION AND PREFERRED EMBODIMENT

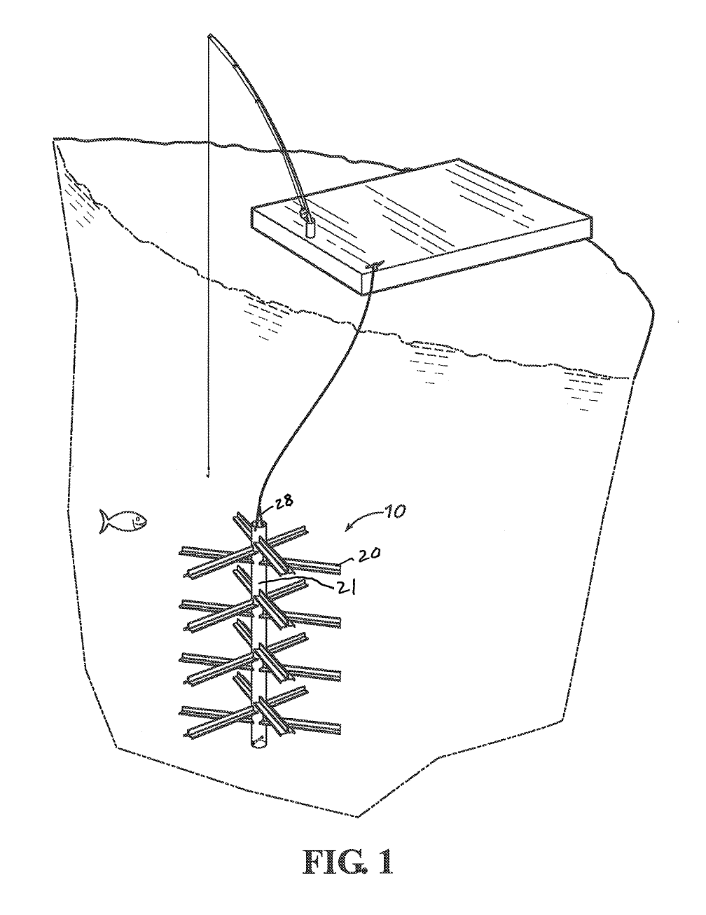

With reference to the drawings, in which like parts have like identifiers, FIG. 1 illustrates a fish habitat 10 constructed in accordance with the principles of a preferred embodiment of the present invention. The habitat 10 is configured for placement within a body of water to provide an environment for fish or other aquatic life. The habitat 10 additionally facilitates fishing for fish and other aquatic life and may be utilized in any body of water, including ponds, lakes, streams, rivers, oceans, etc. Additionally, while the habitat 10 is illustrated in proximity to a dock and a shore, the habitat 10 may be utilized in any portion of the body of water, including shallow and deep portions, and in fully submerged and partially submerged configurations.

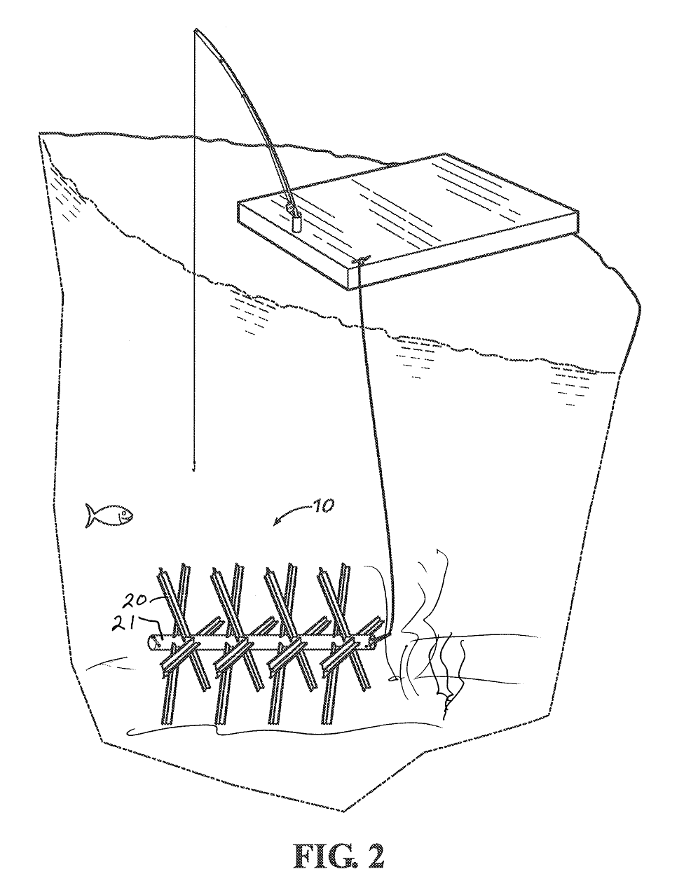

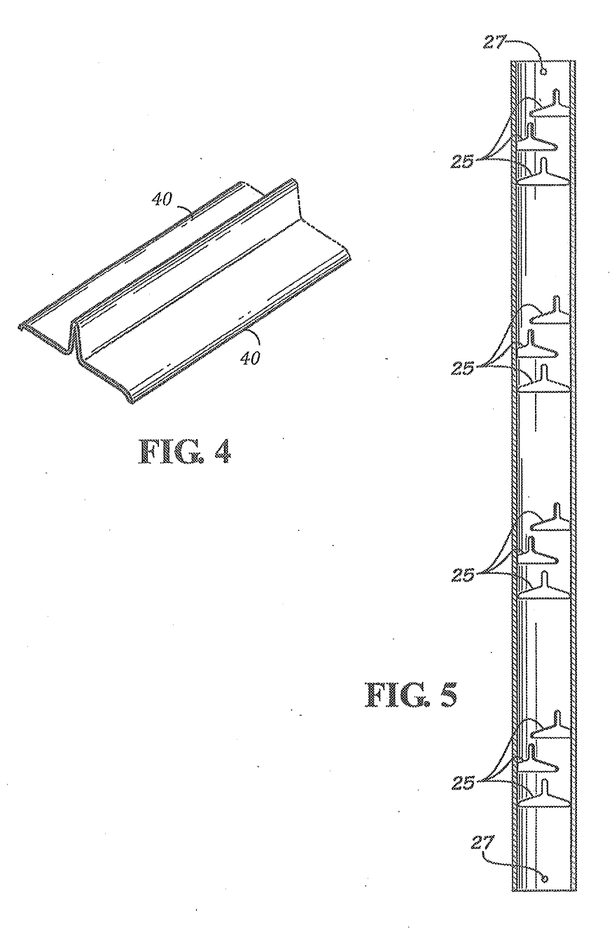

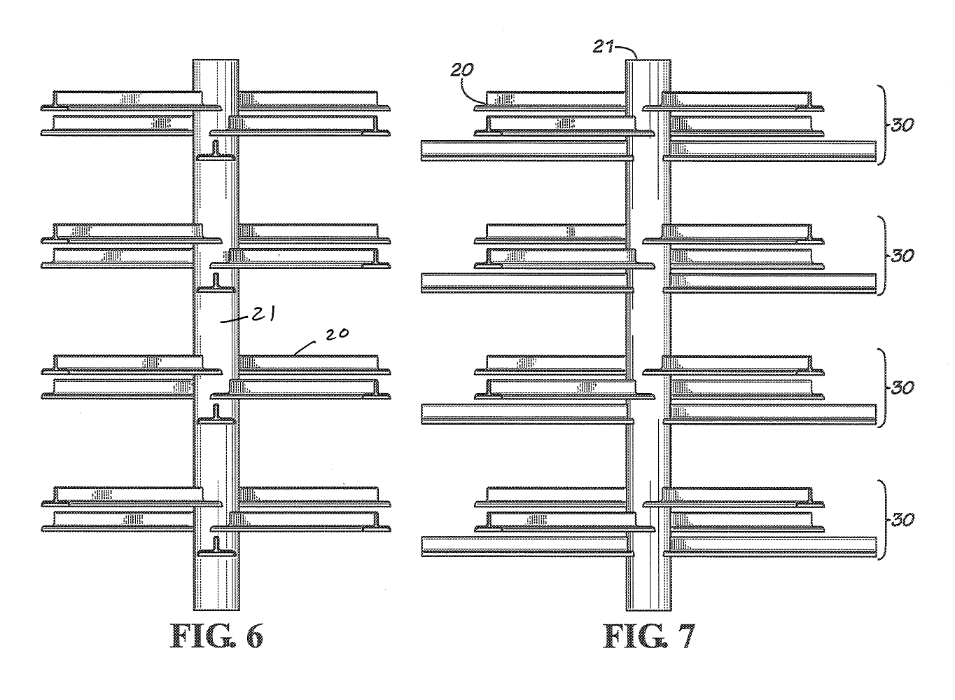

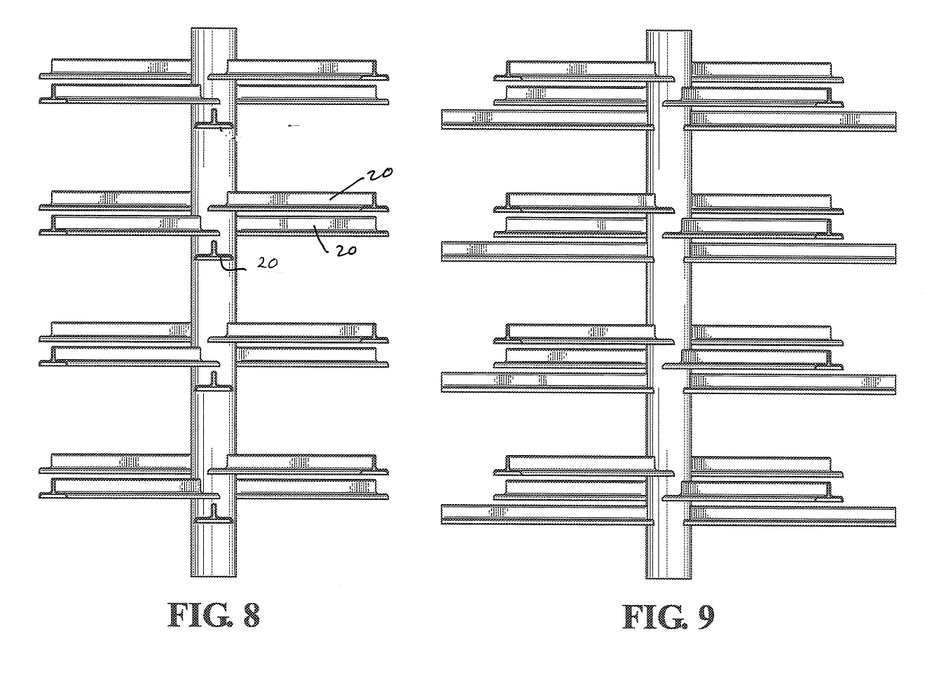

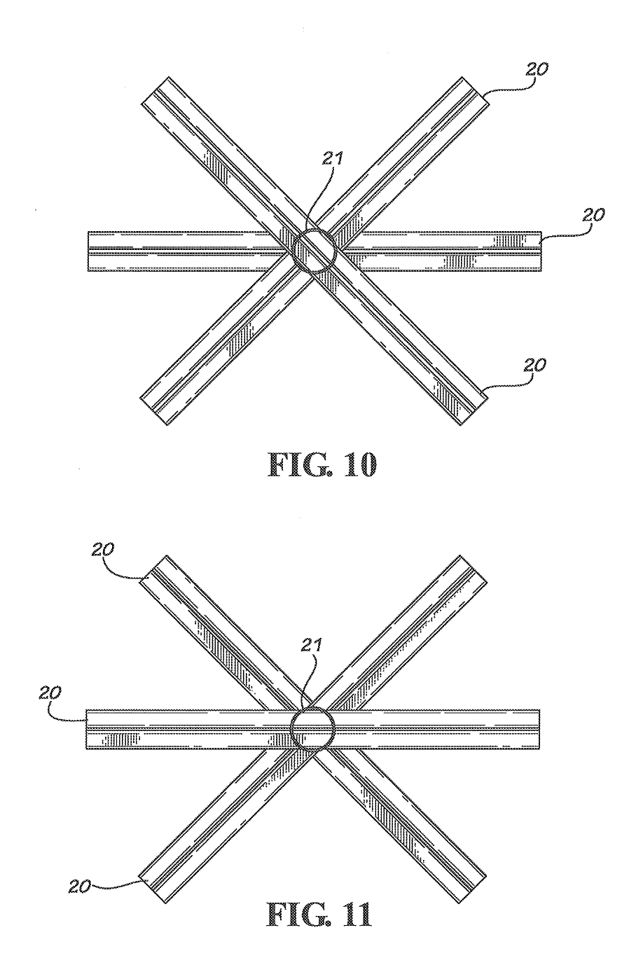

Turning now to FIGS. 1-5, a first preferred embodiment of the present invention is illustrated generally comprising a habitat 10 including an open framework 12. The framework 12 is open such that water, fish, and other aquatic life may easily pass into, through, and around the framework 12. The framework 12 preferably presents a substantially helical shape, as illustrated in FIGS. 1-10. However, the framework 12 may present any appearance and have a non-uniform shape. As described in more detail below, the framework 12 is preferably non-buoyant such that the framework 12 is operable to sit on the bottom of the body of water or dangle in location from a pier or other object. In addition, preferably the framework 12 is water-resistant such that the habitat 10 and framework 12 are not damaged by use and submersion in the body of water.

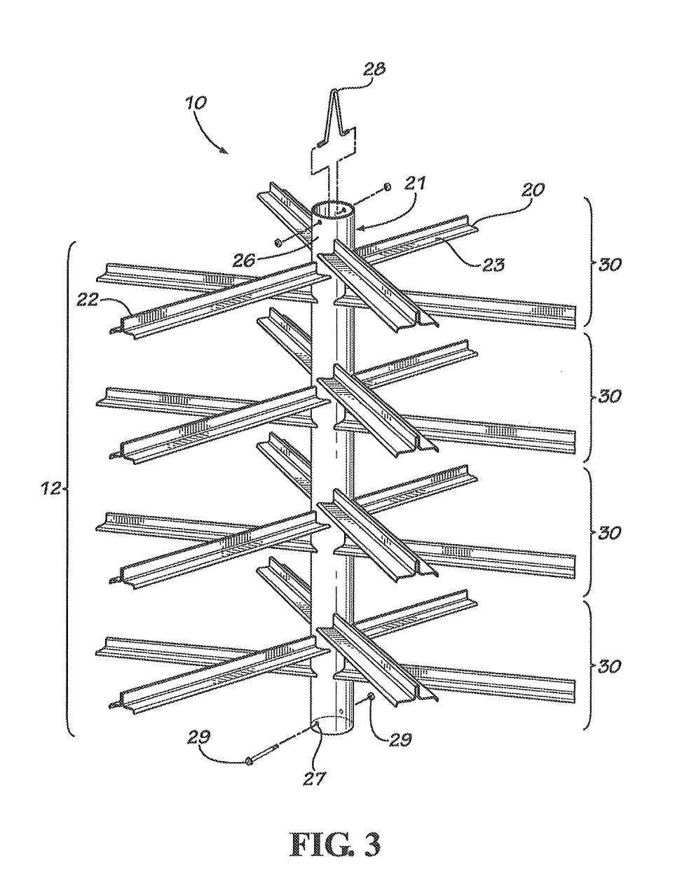

Referring now to FIGS. 3-9, a helical fish aggregation apparatus 10 is shown, according to the present invention, comprised of a plurality of linearly elongated bar slat members 20, and a cylindrical, elongated supporting member 21 forming a generally 4 feet long by 5 feet wide structure for providing an artificial habitat for fish seeking refuge from predators or seeking other fish or food to eat. The support member 21 defines a plurality of spaced-apart through slots or cut outs 25. A plurality of the elongated slats 20 extend though the cut outs to define branch arms of the apparatus. Each cut out 25 defines a first channel having a longitudinal axis in a first direction and an arcuate end and a second channel having a longitudinal axis in a second direction different from the first direction and having opposing arcuate ends. The framework 12 is formed by the slat members 20 and supporting member 21 within the framework 12 such that the framework 12 is open, and provides the framework 12 with its substantially uniform helical shape. In the preferred embodiment, sixteen slat members 20 are constructed of PVC material, wherein each slat member 20 is of a linearly elongated configuration formed with an integral central ridge 22 and integral side flanges 23 disposed in the opposition direction from that of the central ridge 22. Slat members 20 may be of uniform or multiple lengths.

As shown in FIG. 5, elongated supporting member 21 preferably is formed of a central 4″ PVC pipe having cut outs 25 through which are inserted bar slats 20 preferably made of solid, generally rigid, 100% PVC material. A plurality of paired opposing cut outs 25 are drilled in an upper external circumferential surface of the elongated supporting member 21, aligned in a helical series such that each pair of opposing cut outs 25 is preferably separated by a distance of approximately 4 inches along the length of supporting member 21. Each pair of opposing cut outs 25 is designed so as to receive in a semi-interference type fit a linearly elongated slat 20, removably held therein by physical friction. It is envisioned that four slats 20 have a length measuring approximately 4 feet, and eight slats 20 have a length measuring approximately 5 feet. Each slat has opposing flanged edges 23 that extend laterally from a ridge 22 to a respective distal edge 40 curved in the exemplary embodiment in a direction opposing the ridge 22. The ridge 22 has a distal peak that seats in the arcuate end of the first channel. The respective distal edges 40 of the flanged edges 23 seat in the opposing arcuate ends of the second channel. In the exemplary embodiment, the slats 20 have a height of approximately 1.5 inches from bottom of flanged edges 23 to top of ridge 22. Once inserted into the supporting member cut outs 25, the slats 20 extend vertically from the supporting member 21 in a secured fashion thereby forming a helical series of vertically extending slats 20. Elongated supporting member 21 also has holes 27 for use with either a bolt, nut and washer 29 or catch 28.

The slat installation is through the cut-out sections of pipe, forming a compress fit, self-expanding, spring-lock design. The slat being resilient for flexing the flanged edges between a first position and a second position relative to the ridge with the flanged edges in the second position, flex to the second position during installation of the slat in the slot and return to the first position upon installation, to wedge the slat in the slot. The PVC slats 20 are compressed using hand pressure and positioned through the supporting member 21. When the slat 20 is in position, it is released; and the spring-loaded sides of the slat 20 then wedge tight into the walls 26 of the supporting member 21, securing the slat 20 in place.

Holes 27 may be drilled in each end of the supporting member 21 so that a catch 28 may be inserted in one end, allowing the habitat to be hung from a dock or tethered to another stationary object, or retrieved with a boat hook for ease in removal and relocation. Similarly, a bolt 29 may be inserted in holes 27 in the other end of supporting member 21, forming a surface for attaching a rope, chain, or other material which may be used to tether the other end of the habitat 10. No ballast is required, however, as the assembled habitat 10 weighs approximately 17 lbs and will sink on its own because PVC is denser (heavier) than water.

The material is durable such that it may remain submerged in water under potentially extreme conditions without damage, and resists being easily or inadvertently punctured or damaged by a sharp items, such as fish hooks, or by other items. Additionally, the material does not leach harmful matter or otherwise have a negative effect on the body of water, as the durable and water-resistant material does not deteriorate when submerged for extended periods of time. The material utilized in fabricating the present invention is intended merely as a suggestion, and other materials may be employed.

Preferably, the habitat 10 includes at least four sets 30 of three slats 20, as illustrated in FIGS. 1-3 and 6-9, however any number of sets 30 may be utilized, including a single set 30 or even a single slat 20, depending on the desired habitat construction and the needs of the particular body of water. For instance, in a deep body of water, such as a lake or ocean, a larger number of sets 30 may be desired, while in a shallow body of water, such as a stream or pond, a smaller number of sets may be desired. In addition, as described below, habitat 10 may be joined to another habitat 10 to provide an extended framework 12 that provides a large protected area for fish.

In operation, the habitat 10 is transported to a desired fishing location such as a location in proximity to a dock, as illustrated in FIG. 1. The habitat 10 may be pre-assembled, or the habitat 10 may be assembled onsite by coupling the slats 20 and supporting member 21 into a desired configuration.

Once in position, fishing may commence. However, it will be appreciated that fish will generally take some time to begin to reside within the habitat 10. For instance, it may take a few days, or even a few weeks, based on various environmental concerns, for fish to adjust to the change in their environment and for a significant amount of fish to reside within the habitat 10. Additionally, the habitat 10 will eventually become covered with algae and other aquatic life, which provides the habitat 10 with a natural appearance that may be more appealing to fish. If the habitat 10 is to be removed from the body of water, the habitat may be retrieved by grappling the catch 28 and pulling the habitat 10 out of the water. Similarly, once positioned, the habitat 10 may be moved to another position by grappling the catch 28 and lifting, pulling, or dragging the habitat 10 to the desired position. If the habitat 10 has been suspended from a dock or other location into the water, habitat 10 may be moved simply by retracting the suspending rope, wire, or other device.

Referring now more specifically to FIG. 5, a plurality of paired, opposing slat receiving holes 25 are formed at regular 60 degree intervals along the external circumferential surface of supporting member 21. The paired, opposing slat receiving holes 25 are 180 degrees apart from each other on the external circumferential surface of supporting member 21. Sets of three paired opposing slat receiving holes 25 are spaced preferably approximately 2.5 inches apart by length along the external circumferential surface of supporting member 21. Each slat receiving hole 25 is designed so as to receive in a semi-interference type fit a linearly elongated slat 20, removably held therein by physical friction.

It should be noted that attention to state and federal Wildlife rules and regulations prohibiting the use of such an apparatus as the present invention in particular bodies of water should be carefully observed and adhered to. FIG. 12 illustrates in perspective view two helical fish aggregation apparatuses 10a, 10b joined together with a coupling 31. The coupling 31 in the illustrated embodiment is a reducing coupling having a first diameter for receiving an end of a first supporting member 21a and a second diameter for being received in the open end of a second supporting member 21b. The coupling 31 in an alternate embodiment defines opposing holes in respective end portions for securing the coupling 31 to the respective supporting member 21 with the bolt and nut 29.

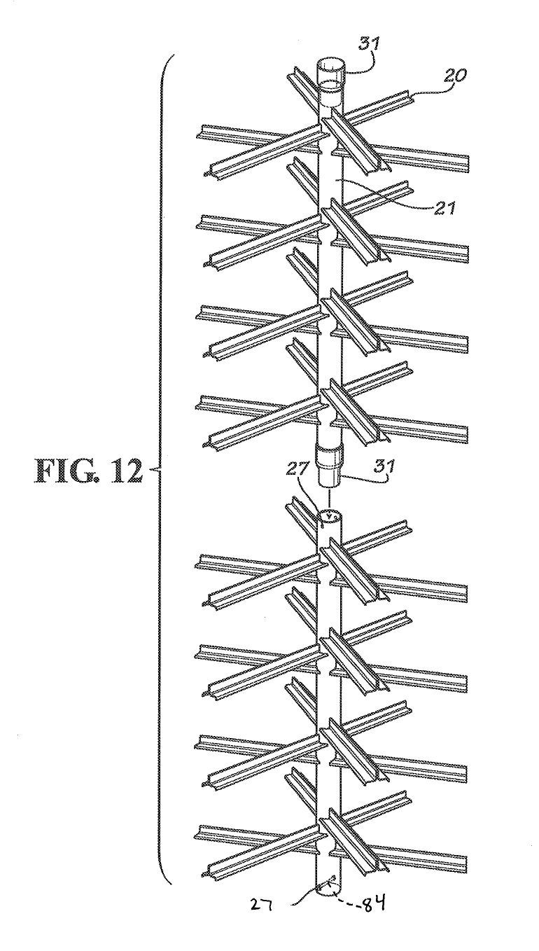

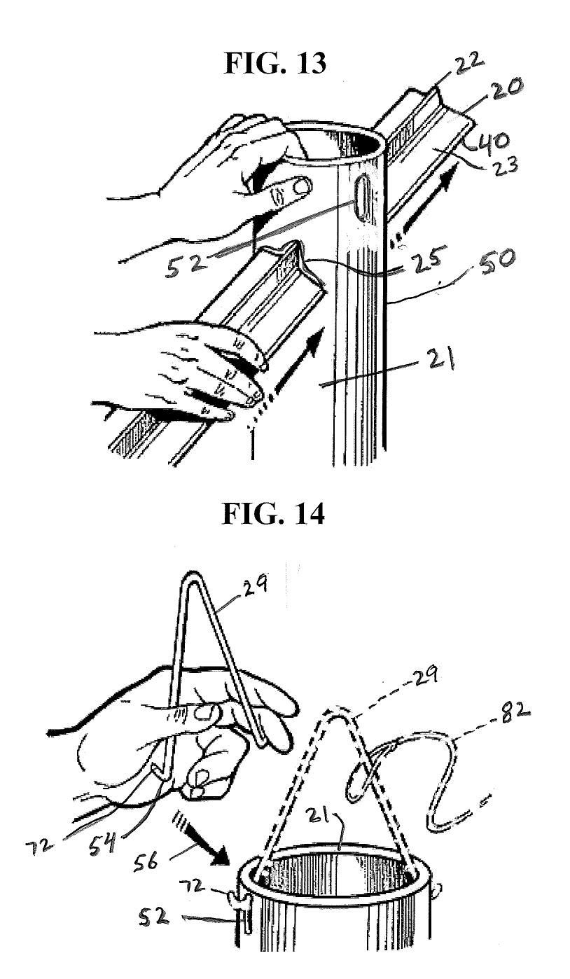

FIG. 13 is a perspective detailed view of an alternate embodiment fish aggregation apparatus 50. This embodiment differs from the fish aggregation apparatus 10 disclosed above, in that at least one of the opposing end portions (and preferably, the upper one) of the supporting member 21 define a pair of opposing longitudinal slots 52 or cut-throughs, for receiving a respective curved seat portion 54 of the catch 28, or alternate embodiment catch 29 as shown in FIG. 14. FIG. 14 further illustrates a user's hand holding the catch 29 for installation and spaced-apart shows the catch 29 in broken-line depicting as installed on the supporting member 21, with an arrow 56 generally indicating the action of installation.

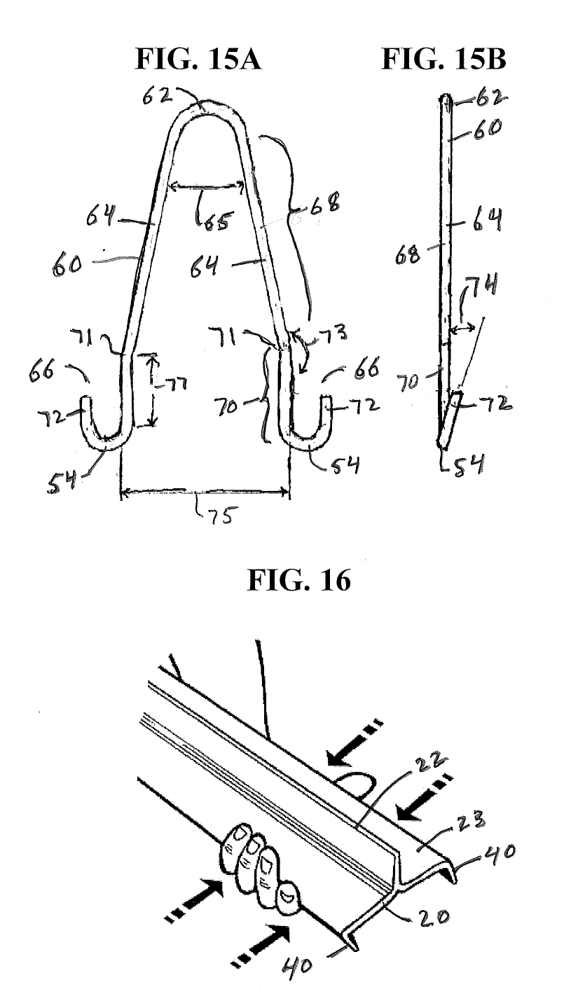

FIG. 15A is a front plan view of a handle 60 configured for use with the helical fish aggregation apparatus 50 illustrated in FIG. 13. The handle 60 is a longitudinally elongated member configured with a medial arcuate portion 62 to define a pair of legs 64 that extend at diverging angles 65 relative to each other about an axis through a center point of the arcuate portion. In the exemplary embodiment, the elongated member comprises a rod, and more particularly, the rod comprises a ¼ inch diameter 304 SS (stainless steel) wire. Each leg 64 extends to an engaging foot 66 that engages with the slot 52. The leg 64 in the illustrated embodiment has a first portion 68 and second portion 70. The first portion 68 extends longitudinally from an exit of the arcuate portion 62 to an intermediate bend 71 that disposes the second portions 70 parallel relative to each other and terminating in the respective engaging foot 66. The engaging foot 66 defines the arcuate seat portion 54 from which a stub 72 extends to free distal end. In the illustrated embodiment, the arcuate portion 62 concavely curves in a first direction and the arcuate seat portions 54 concavely curve in second directions opposing the first direction. As discussed below, the engaging feet 66 being slidingly extended through a respective one of the opposing slots 52, engages the supporting member 21 with the arcuate seat portion 54 within the slot 52 and the stub 72 outwardly thereof for restraining reverse passage therethrough during normal use for retaining the handle 60 engaged to the supporting member 21, for aquatic fish aggregation apparatus handling purposes.

As illustrated in side view in FIG. 15B, the stub 72 extends at an oblique angle 74 relative to a plane defined by the leg 64. The angle 74 in the illustrated embodiment is about 15°. In the exemplary embodiment, the handle forms from ¼ inch diameter 304 SS (stainless steel) wire. The legs 64 diverge 65 at about a combined 23 degree angle. The intermediate bend 71 defines an acute angle 73 on an outward surface of the leg 64 of 169 degrees, to space 75 the second portions 70 of the legs 64 4.0 inches apart. The second portion 70 has a length of 1.7 inches. The radius of the seat portions 54 is 0.125 inches, and the stub 72 extends linearly therefrom 0.75 inches. The height of the handle between an apex of the medial portion and an apex of the seat portion is 8.22 inches. The foregoing describes the illustrative embodiment and is not limiting as other dimensional aspects are within the skill of an artisan upon consideration of the present disclosure. Further, it is to be appreciated that an alternate embodiment of the handle employs a tight J-bend to define the seating portion 54 and extending stub 72 such as the catch disclosed hereat and illustrated in FIG. 14.

FIG. 16 is a perspective view of the slat 20 being handled for installation in the helical fish aggregation apparatus 50 illustrated in FIG. 13. The slat 20 is gripped and squeezed inwardly for slidingly passing the slat through a selected slot 23 in the supporting member 21.

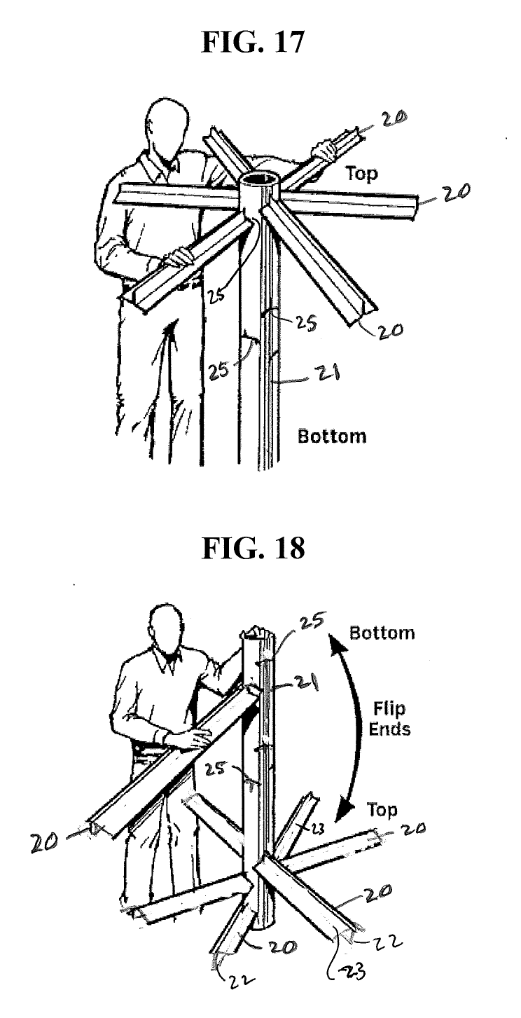

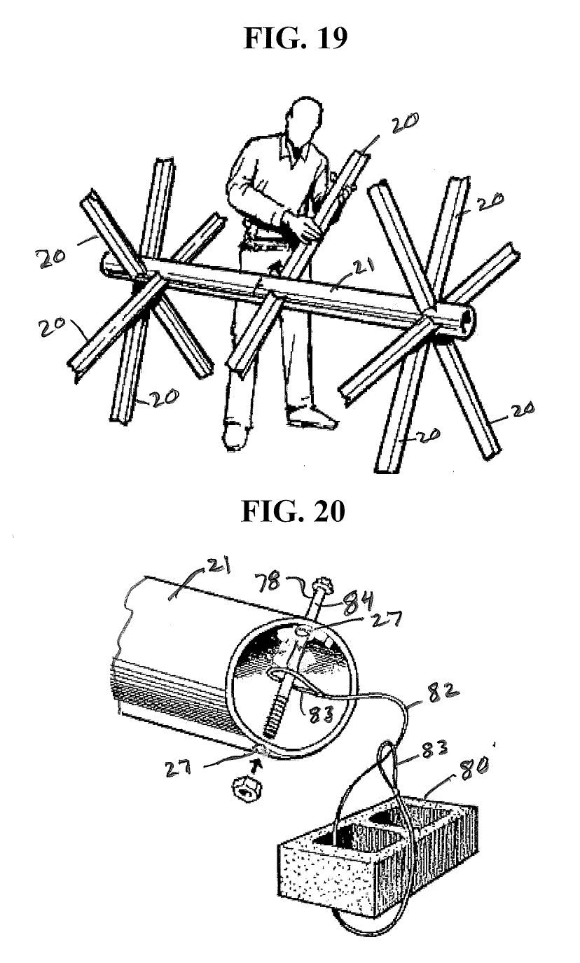

FIG. 17 is a perspective view of slats 20 at an upper end of the supporting member 21 during installation of the slats in the helical fish aggregation apparatus 50. FIG. 18 is a perspective view of the helical fish aggregation apparatus 50 during a subsequent installation step for positioning the slats 20 in a bottom portion of the helical fish aggregation apparatus. FIG. 19 is a perspective view of the helical fish aggregation apparatus 50 during a subsequent step of installing slats 20 in an intermediate portion of the helical fish aggregation apparatus.

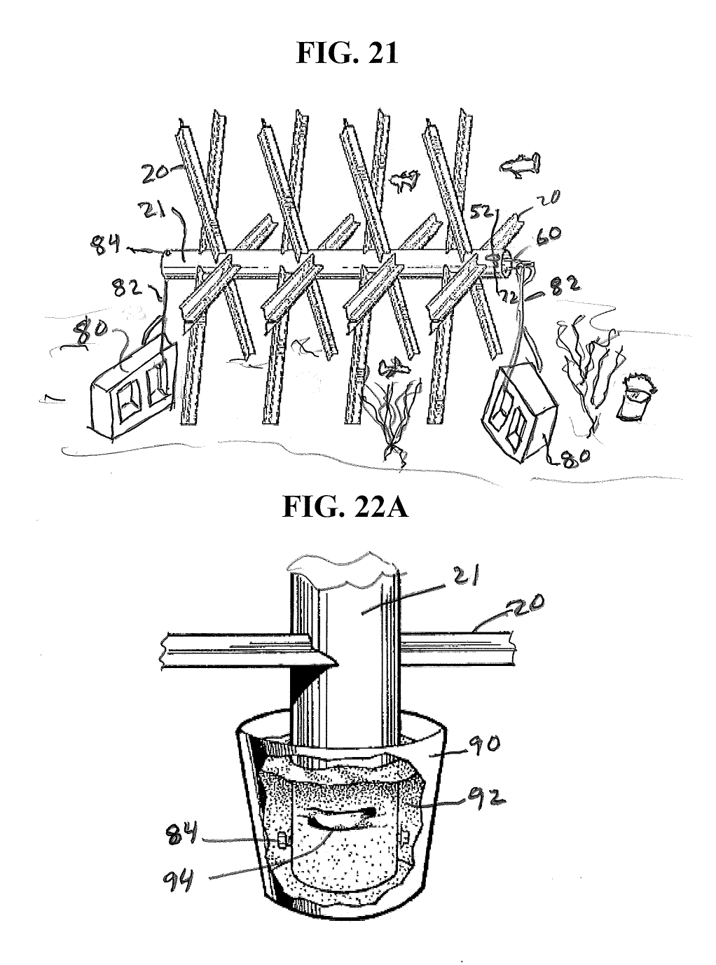

FIG. 20 is a perspective view of the bottom end of the helical fish aggregation apparatus 50 having a weight 80, such as the illustrated cement block, attached with a lanyard 82 to a support member 78. The lanyard 82 has opposing looped ends 83. The support member 78 in the illustrated embodiment is a bolt 84 that passes through the openings 27 of the supporting member 21 and is secured with a nut. The lanyard 82 encircles the weight 80. A first looped end 83 passes through openings in the weight 80 and through the other of the looped end 83. The bolt 84 extends through the opening 27, through the first looped end 83, and the other opening 27, and is secured with a nut. As illustrated in FIG. 21, the weight 80 holds the helical fish aggregation apparatus 50 on a bottom surface of an aquatic environment (illustrated horizontally disposed with a second weight 80 attached to the handle 60).

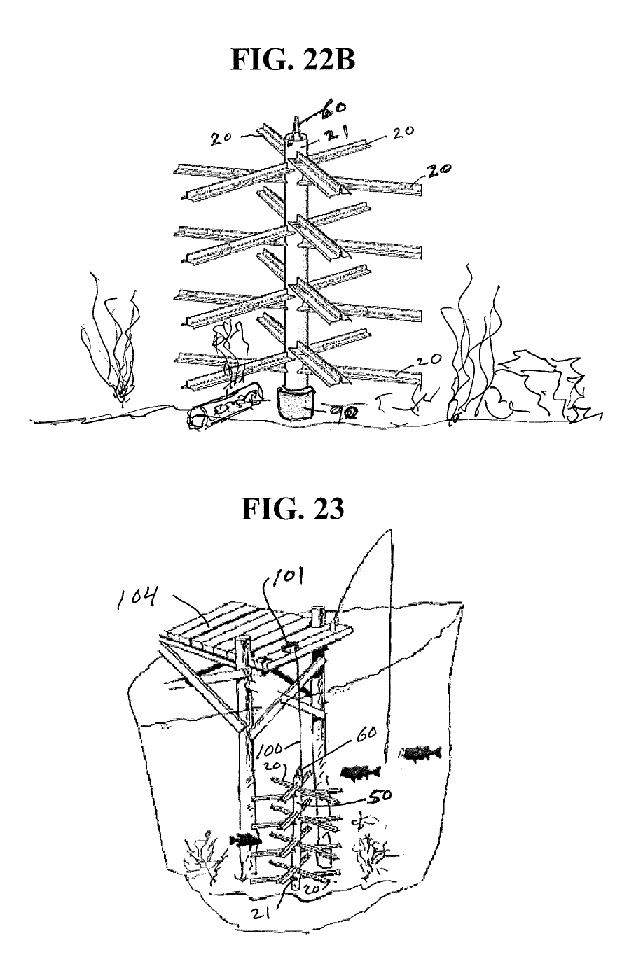

FIG. 22A is a perspective cut-away view of a bottom end of the helical fish aggregation apparatus 50 with a weighted base 90 for vertical placement on the bottom surface of the aquatic environment (as shown in perspective view in FIG. 22B). The weighted base 90 in the illustrated embodiment comprise a cementitious mixture 92 poured and cured within a container such as small pail or bucket. In this embodiment, a lower portion of the supporting member 21 in this embodiment defines opposing portal openings 94. The bottom end embeds within the cementitious mixture which also flows through the portal openings 94, so that, upon curing, secures the weighted base 90 to the supporting member 21.

FIG. 23 is a perspective view of the helical fish aggregation apparatus 50 attached with a line 100 to a cleat 101 of a dock 104 or pier of an aquatic environment. The line 100 attaches to the handle 60 or catch 28. The line 100 allows measured passage of the fish aggregation apparatus 50 through the water to a desired position such as suspended intermediate the surface and bottom, or standing on a bottom surface.

With reference to FIGS. 13 and 17, the fish aggregation apparatus 50 readily assembles with the slats 20 and handle 60. With the supporting member 21 standing vertical, a respective one of the slats 20 is gripped on the opposing arcuate edges 40 and squeezed inwardly, or cupped, as shown in FIG. 16. The leading end of the slat 20 inserts through the a respective ones of the opposing slots 25 as discussed above. An assembler, while holding the cupped slat 20 in one hand and the supporting member 21 in the other hand, positions the opposing distal edges, or corner points of the slat, into the notched slots 25. The assembler works the slat 20 through a first one of the slots 25 and through the opposing slot aligned therewith. The assembler works the slat by pinching the opposing edges 40 and sliding the slat longitudinally through the slot 25. The slat 20 conforming substantially in profile to the slot 25 seats in the slot with a semi-interference fit upon release of the inwardly gripping force on the slat. The ridge 22 seats in the first channel while the opposing distal edges 40 of the flanges 23 seat in the opposing ends of the second channel. The assembler works the slat 20 to substantially center the slat relative to the supporting member 21, although alternatively, the slats may be disposed off-center. The installation process is continued for the other of the slats 20 and slots 25, as shown in FIG. 17. Once inserted into the slots 25 of the supporting member 21, the slats 20 extend from the supporting member in secured fashion thereby defining a tree-like branched structure for an aquatic habitat for aqueous organisms.

As illustrated in FIG. 18, the slots 25 in the bottom portion readily receive the respective slats 20 by first inverting the supporting member 21. By flipping the supporting member 21, the slots 25 are more easily accessed by an installer who is standing. Thereafter, and further, the intermediate slats are more readily installed in a mid-section of the supporting member 21 by positioning the partially assembled fish aggregation apparatus 50 horizontally as illustrated in FIG. 19.

The catch 28, or handle 60 installs in an open end of the supporting member 21, as illustrated in FIG. 14 with the foot 66 engaged to the slot 52. This is accomplished by the assembler grasping the handle 60 with one hand and pinching the opposing legs 64 together to move the legs towards each other. This brings the seat portions 54 and stubs 72 laterally inwardly for fitting into the open end of the supporting member 21. With reference to FIG. 15B, the stub 72 preferably extends at an angle relative to the legs 64.

The assembler accordingly positions the handle 60 with the legs in a first direction at an angle relative to a longitudinal axis of the supporting member 21 to align the stubs 72 with the respective slot 52 for passing the stubs through the slots. The installer relaxes the inwardly squeezing pressure to allow the legs 64 to move apart. The assembler moves a first one of the stubs 72 through the longitudinal slot 52, and thereby seats the respective seat portion 54 in the slot. Thereafter, or together, the second seat portion 54 similarly enters the opposing slot 52 for extending the stub 72 outwardly of the supporting member 21. The relaxing grip on the handle 60 allows the seat portions 54 to seat in the respective slots 52. After the stubs 72 extend through the slots 52, the installer moves the handle 60 in a second opposite direction and disposing the stubs 72 at an oblique angle outwardly of the wall of the supporting member 21 relative to a longitudinal axis of the supporting member 21 with the seating portions 54 in the respective slot 52. The angled stubs 72 restrict casual passage back through the slots 52 such as during positioning of the assembled fish aggregation apparatus 50. A rope or line optionally attaches to the handle after engagement to the supporting member 21. The line enables the assembled aquatic tree structure to then be lowered into a body of water controllably for maintaining the structure vertical during positioning and placement, for example, on a bottom surface or suspended at a selected depth.

With reference to FIG. 20, the fish aggregation apparatus 50 installs for bottom anchoring. The first one of the looped ends 83 of the lanyard 82 passes through openings in the cement block or weight 80 and through the other of the looped ends 83. The bolt 84 extends through the opening 27, through the first looped end 83, and the other opening 27, and is secured with a nut. As illustrated in FIG. 21, the weight 80 holds the helical fish aggregation apparatus 50 on a bottom surface of an aquatic environment (illustrated horizontally disposed).

With reference to FIGS. 22A and 22B, the fish aggregation apparatus 50 alternatively installs for bottom anchoring with a cast concrete base 90. A lower one of the slats 20 installs in the respective lower slot 25, and the bolt 84 may be attached to the supporting member 21. The cement base 90 is cast in a pail or container, such as a plastic 5 quart pail. The inside surface may be optionally prepared with a release agent, such as a light coating of a household cooking spray. A concrete mixture is prepared for filling the pail. For example, a 5 quart pail of cement mixture is approximately 20 pounds. It is preferred to use more concrete mix for aquatic environments subject to currents.

The concrete mixture fills the pail and the supporting member 21 positioned vertically and centered. The concrete mixture covers and flows through the portal openings 94 to fill into a portion of the interior of the supporting member 21. Upon curing of the cement mixture (typically about 12 hours), the pail is tapped gently to dislodge the cement base 90 from the pail. Further curing of the cement may be necessary as appropriate. The fish aggregation apparatus 50 with the weighted base 90 provides for vertical placement on the bottom surface of the aquatic environment (as shown in perspective view in FIG. 22B).

The fish aggregation apparatus 50 alternatively positions suspended in the aquatic environment as illustrated in FIG. 23. The lanyard 82 attaches to the handle 60. This is accomplished by one of the looped ends 83 passing through the opening formed by the attached handle and through the other of the looped ends 83. The first looped end 83 attaches to a cleat or bracket secured to a dock or pier. The lanyard 82 suspends the fish aggregation apparatus 50 in the aquatic environment. Alternatively, a rope or other line readily attaches to the handle 60 after engagement to the supporting member 21. The line enables the assembled fish aggregation apparatus 50 to be then lowered into the water controllably for maintaining the fish aggregation apparatus vertical during positioning and placement on a bottom surface of the aquatic environment. An elongated line allows tie-off at a selected depth as well as recovery or attaching a buoy for later locating. If the fish aggregation apparatus 50 for the fish habitat structure is to be removed from the body of water, the habitat may be retrieved by grappling the handle 60 and pulling the habitat 10 out of the water. Similarly, once positioned, the habitat 10 may be moved to another position by grappling the handle 60 and lifting, pulling, or dragging the habitat 10 to the desired position. If the habitat 10 has been suspended from a dock or other location into the water, the habitat 10 may be moved simply by retracting the suspending rope, wire, or other device.

Accordingly, the handle 60 for the aquatic aggregation apparatus 50 provides for placement thereof by measured passage with the line 100 connected thereto for shelteringly attracting and accumulating aquatic organisms, in which handle formed of the elongated member configured with the medial arcuate portion 62 and the pair of distal arcuate seating portions 54 for passage through and engagement with respective longitudinal opposing slots 52 of the supporting member 21 that further receives the plurality of elongated slats 20 through spaced-apart slots 25 therein to define arms for the attracting and accumulating of aquatic organisms to and about the aggregation apparatus for facilitating fishing habitats, allowing the habitat apparatus to be hung from a dock or retrieved with a boat hook for ease in removal and relocation.

### Operation of the Preferred Embodiment

The foregoing description is included to disclose the structure of exemplary embodiments of the fish aggregation apparatus and to illustrate the operation of the embodiments, and is not meant to limit the scope of the invention. As one can envision, an individual skilled in the relevant art, in conjunction with the present teachings, would be capable of incorporating many minor modifications that are anticipated within this disclosure. Therefore, the scope of the invention is to be broadly limited only by the following claims.

I claim:

1. A fish aggregation apparatus comprising:
a linearly elongated, cylindrical supporting member;
a plurality of linearly elongated slats extending perpendicularly to the cylindrical supporting member,
wherein the supporting member is formed with aligned pairs of opposing slat-receiving cut-outs in a wall of supporting member, the pairs of slat-receiving cut-outs spaced vertically and accurately relative to an adjacent pair of the slat-receiving cut-outs,
said supporting member, when engaged with said slats, forms a generally helix-like structure for providing an artificial habitat for fish; and
an elongated member formed with an arcuate medial portion concavely curved in a first direction and two leg portions extending longitudinally therefrom at diverging angles to respective opposing distal ends that each define a foot for engaging an end of the supporting member,
whereby the elongated member, being attached to a line, provides measured placement of the fish aggregation apparatus within an aquatic environment.

2. The fish aggregation apparatus as recited in claim 1, wherein the respective foot comprises an accurate seating portion and a stub extending to the respective distal end.

3. The fish aggregation apparatus as recited in claim 2, wherein the seating portion is concavely curved in a second direction opposite the first direction.
whereby the handle with the engaging feet being slidingly extended through respective opposing slots in the tubular member, engages the tubular member for aquatic tree handling purposes.

4. The fish aggregation apparatus as recited in claim 2, wherein the supporting member defines in an end portion a pair of opposing longitudinally elongated slots, whereby the stubs, being extended through the respective slot, disposes the seating portion therein.

5. The fish aggregation apparatus as recited in claim 4, wherein the stubs are disposed an angle relative to a plane defined by the legs of the handle.

6. The fish aggregation apparatus as recited in claim 1, wherein the supporting member defines the cut-outs in a plurality of groups positioned at 2.5 inches from each other and each group spaced apart from an adjacent group a second spacing greater than 2.5 inches.

7. The fish aggregation apparatus as recited in claim 1, wherein the supporting member defines the pairs of cut-outs at 60 degree spacing from an adjacent pair of cut-outs.

8. The fish aggregation apparatus as recited in claim 1, further comprising:
a support member engaged to a lower portion of the supporting member;
a weight member; and
a lanyard for connecting the weight member to the support member,
whereby the weight member, being connected to the supporting member, secures the secures the fish aggregation apparatus to a placement on a bottom surface of the aquatic environment.

9. The fish aggregation apparatus as recited in claim 1, further comprising:
a second fish aggregation apparatus comprising the linearly elongated, cylindrical supporting member having the plurality of cut-outs and the plurality of slats; and
a coupling that connects an upper end of the second fish aggregation apparatus to a lower end of the first fish aggregation apparatus,
whereby the first and second fish aggregation apparatus form an assembly for placement in an aquatic environment for aquatic organisms.

10. A handle for engaging a tubular member of an aquatic tree structure, comprising:
a continuous elongated member having opposing distal ends, the elongated member formed with an arcuate medial portion concavely curved in a first direction to define an upper end of the handle;
a pair of opposing legs extending from the medial portion at diverging angles relative to a radial line through a center point of the medial portion to a respective engaging foot;
each engaging foot having an accurate seating portion and a stub extending to the respective distal end, the arcuate seating portion concavely curved in a second direction opposing the first direction for extending outwardly of a longitudinal slot in a wall of a tubular supporting member of an aquatic tree structure to dispose the seating portion therein,
whereby the handle, being engaged to the tubular supporting member of the aquatic tree structure for attaching a line for measured placement of the aquatic tree structure in an aquatic environment.

11. The handle as recited in claim 10, wherein each of the legs comprises a first segment and a second segment, the first segment extending at the divergent angle to a bend and the second portion extending from the bend parallel to the opposing second portion.

12. The handle as recited in claim 11, wherein the first segment extends linearly from the medial portion.

13. The handle as recited in claim 12, wherein the stub extends at an oblique angle relative to the leg.

14. The handle as recited in claim 12, wherein the stub extends at about a 15 degree angle relative to a longitudinal axis of the leg.

15. The handle as recited in claim 10, wherein the elongated member comprises a wire rod.

16. The handle as recited in claim 15, wherein the wire rod is ¼ inch diameter 304 stainless steel.
